(19) United States
(12) Patent Application Publication
(10) Pub. No.: US 2021/0321841 A1
(43) Pub. Date: Oct. 21, 2021

(54) WIRELESS DUST COLLECTION APPARATUS, SYSTEM, AND METHOD OF USE

(71) Applicant: Joel Danowitz, Champaign (US)

(72) Inventor: Joel Danowitz, Champaign (US)

(21) Appl. No.: 17/270,339

(22) PCT Filed: Sep. 16, 2019
(86) PCT No.: PCT/US19/51297

§ 371 Date: Feb. 22, 2021

(51) Int. Cl. A47L 7/00; A47L 9/28; A47L 9/00

(52) U.S. Cl. CPC A47L 7/0095; A47L 2201/06; A47L 9/0072; A47L 9/2894

(57) ABSTRACT

Embodiments of the present invention provide a wireless dust collection system capable of integration into an existing or new dust collection configuration and capable of wireless activation in response to the activation of a connected workshop implement or in response to a user input through a user interface. The wireless collection system has at least one gate mechanism assembly, at least one wireless trigger assembly, an intermediary hub, a collector, a collector bin, and at least one wireless control interface.

### CROSS-REFERENCE TO RELATED APPLICATIONS

This application claims the benefit of U.S. Provisional Application No. 62/753,795, filed Nov. 6, 2018.

### BACKGROUND OF THE INVENTION

The present invention relates to workshop dust collection. Particularly, a wireless dust collection system that may be integrated into an existing collection configuration and capable of wireless activation in response to the activation of a connected workshop implement; the wireless collection system having a gate assembly, a wireless trigger assembly, an intermediary hub, and at least one wireless control interface.

Workshops, fabrication shops, and woodshops are regular places in which a multitude of tools and other implements are utilized to multiple ends. Given task may involve the cutting, shaping, and tooling of wood, metal, or other materials, all of which can create a large amount of dust or sawdust. In order to both maintain the quality of air inside the workshop, as well as keep the work area clean and clear, dust collection systems have been designed to enable easy collection and removal of dust particles during the course of a tool's operation.

Current dust collection systems typically consist of tubing or ductwork and a connected vacuum or powered suction unit that may be activated upon the needs of the user during the course of work. The ductwork usually further contains one or more gates disposed within, configured to open and close. The opening and closing of the gate is typically facilitated through a mechanical means involving a sliding or rotating plate. Some systems include a wired electromechanical actuator coupled to the plate and configured to allow a wired binary switch to open or close the blast gate. In many cases, these blast gates are further wired in series, also known as “daisy-chaining.” Doing so not only leaves the entire system reliant on a single outlet or circuit, but also may limit the ability of gates to be independently activated from one another. The gates are also still limited to a simple binary status of open or closed. There is a present need for a wireless dust collection system with independently-operated wireless blast gates.

These modern dust collection systems also typically consist of self-contained blast gates with either integrated, closed mechanisms, or even contained within the pre-fabricated tube or ductwork. As such, these systems can be both cumbersome and expensive to integrate into an already existing workshop and can be further expensive to repair or replace. In many instances, older dust collection systems with manually-operated blast gates may need to be completely removed and replaced by the new system. The same may occur in a situation where a single self-contained blast gate malfunctions. There is a present need for a dust collection system having removable wireless blast gate mechanisms that may further be integrated into and update existing systems or replaced and repaired.

Modern dust collection systems may also contain a control interface, either centralized or delocalized, that consists of the aforementioned binary switch set-up hard-wired to the system and located within the workshop, typically on each blast gate itself. The control interface further may only allow for activation of one blast gate at a time or may only be activated by physically activating a switch on the blast gate itself. Such collection systems limit the ability of a user to work about the workshop without space-consuming tubing or ductwork for the collection system or limits the user to a confined area of the workshop for tasks and activities that necessitate the use of a dust collection system. Moreover, current dust collection systems lack the ability to monitor airflow, collection capacities, and modulation of blast gate positions. There is a present need for a dust collection system that allows wireless activation and modulation of the dust control system.

The present invention attempts to remedy the shortcomings of prior art dust collection systems used in workshops by providing an implement-activated wireless dust collection system having at least one removable blast gate mechanism assembly, an intermediary hub, at least one trigger assembly, and at least one wireless control interface. The present invention also attempts to remedy shortcomings of prior art dust collection systems by further providing a wireless dust collection system having a plurality of sensors configured to monitor at least one of airflow, air quality, collected dust levels, and

### BRIEF DESCRIPTION OF THE INVENTION

The present invention provides a dust collection system capable of automatic wireless activation in response to activation of a connected workshop implement. In one embodiment of the invention, the dust collection system is configured with at least one gate mechanism assembly, at least one wireless trigger assembly, an intermediary hub, a collector, a collector bin, and at least one wireless control interface.

The intermediary hub may be configured to receive a plurality of signals from the at least one blast gate mechanism assembly, the at least one trigger assembly, the at least one sensor module, the collector, and the at least one wireless control device. Further, the intermediary hub is configured as a communication nexus for the wireless dust collection system, and may be further configured as a communication bridge between the wireless dust collection system and an external network.

The blast gate mechanism assembly comprises a force lever, an anchoring plate, a sled member, a servomotor or rotary actuator, and a housing member. The blast gate mechanism assembly may be configured to couple a blast gate and open or close the blast gate through moving a plate of the blast gate a distance along a planar path.

The at least one trigger assembly comprises a microcontroller unit and a wireless communication device, both configured to interface with the intermediary hub and transmit signals or telemetry thereto, further comprising data regarding a measure and status of electrical current being supplied through the trigger assembly and to the connected implement or tool. The at least one trigger assembly may be configured to allow modulation of, and control of, electrical current supplied to a connected implement or tool.

The plurality of sensor modules may each be configured to monitor and transmit telemetry on airflow, air quality, collector bin levels, electrical current, and blast gate status.

The wireless control device of the dust collection system may comprise a computer or mobile application having a computer-implemented protocol and graphical user interface configured to allow a user to monitor and modulate each component of the dust collection system.

The methods, systems, and apparatuses are set forth in part in the description which follows, and in part will be obvious from the description, or can be learned by practice of the methods, apparatuses, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed. More details concerning these embodiments, and others, are further described in the following figures and detailed description set forth herein below.

### BRIEF DESCRIPTION OF THE DRAWINGS

FIG. 1 provides a flowchart illustrating the overall functional steps of the dust collection system.

FIG. 2 illustrates a profile view of the intermediary hub of the wireless dust collection system.

FIG. 3 illustrates a perspective view of the blast gate mechanism assembly of the wireless dust collection system affixed to a blast gate.

FIG. 4 illustrates an exploded view of the blast gate mechanism assembly of the wireless dust collection system.

FIG. 5 illustrates a perspective view of the wireless trigger assembly of the wireless dust collection system.

FIG. 6 illustrates a perspective view of an alternative embodiment of the wireless trigger assembly of the wireless dust collection system.

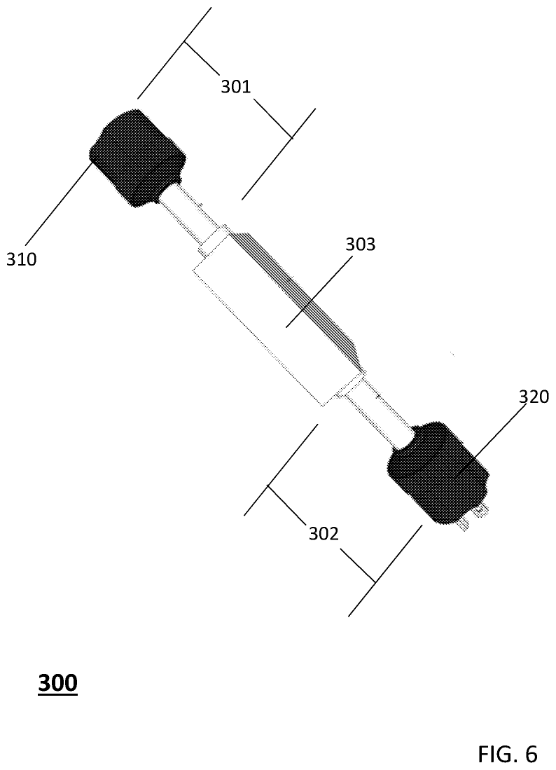

FIG. 7 illustrates a flowchart of the network of the intermediary hub of the wireless dust collection system.

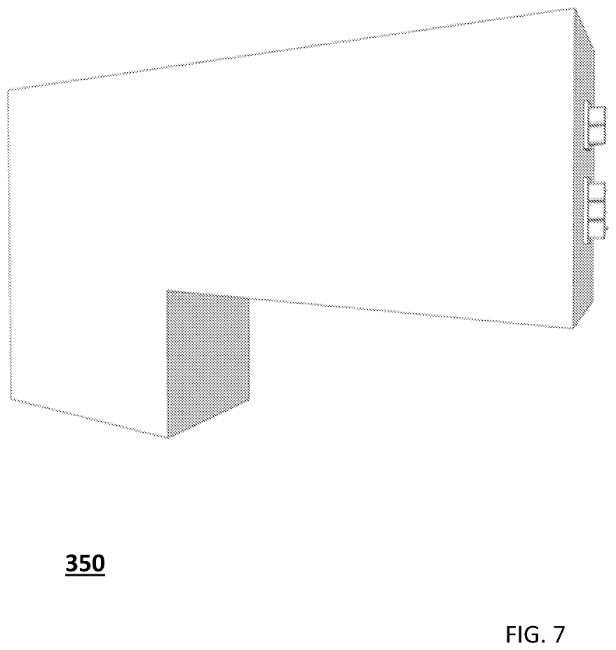

FIG. 8 provides a flowchart illustrating the device registration process of the wireless dust collection system.

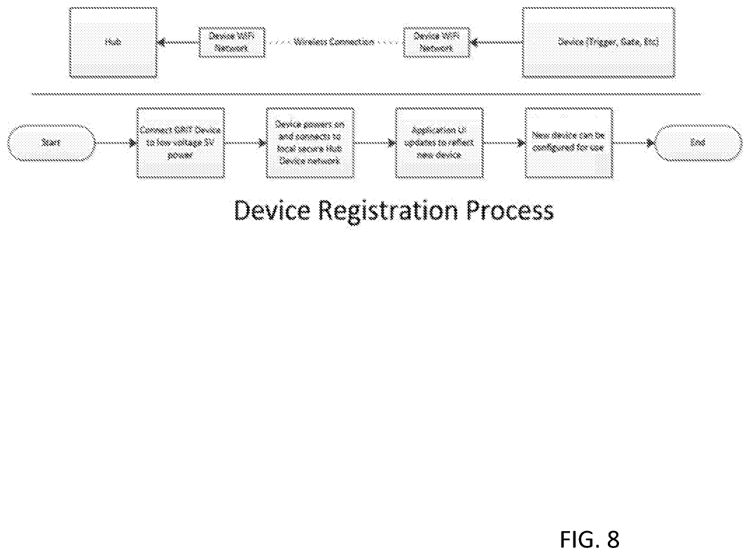

### DETAILED DESCRIPTION OF THE INVENTION

The present invention is described in reference to the accompanying drawings and following embodiments that are presented for the purpose of illustration and should not be construed to limit the scope of the invention thereto.

The present invention relates to workshop dust collection. Particularly, a wireless dust collection system capable of wireless activation in response to the activation of a connected workshop implement, the dust collection system having at least one blast gate mechanism assembly, at least one wireless trigger assembly, an intermediary hub, at least one sensor module, a collector, and at least one wireless control device.

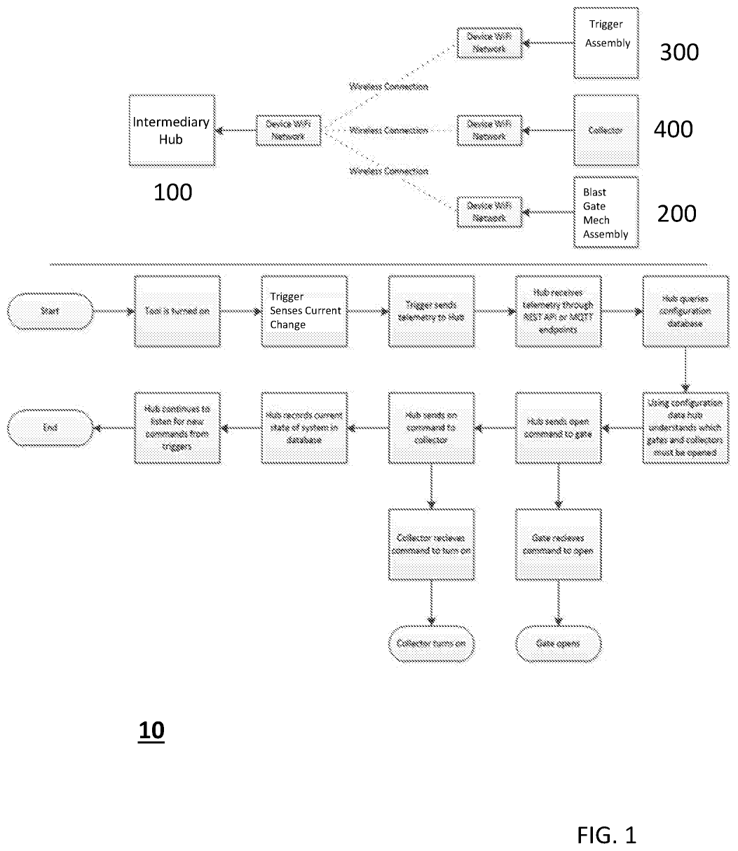

One embodiment of the present invention, as shown in FIG. 1, provides a wireless dust collection system 10, comprising a collector 400 and at least one blast gate mechanism assembly 200 removably coupled to a blast gate and in connection with an intermediary hub 100; the intermediary hub 100 further being connected to at least one sensor module 110 and at least one trigger assembly 300 coupled to a workshop implement. The wireless dust collection system 10 may be activated automatically in response to an electrical signal to, and operation of, a workshop implement such as a drill press, table saw, bandsaw, planer, metal lathe, milling machine, paint and chemical fume hood, shop vacuum, or other tool that may generate dust during operation. The system may also be activated through use of a wireless control device having a user interface, such as a computer or mobile phone application.

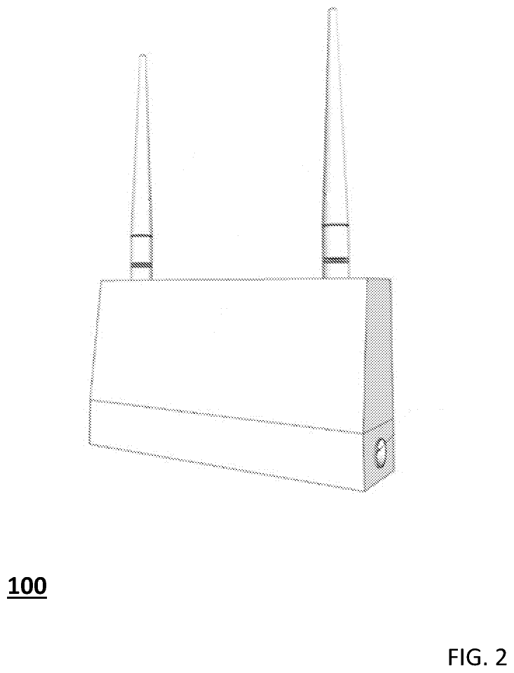

The intermediary hub 100, as shown in FIG. 2, is configured to receive a plurality of signals from the at least one blast gate mechanism assembly 200, the at least one trigger assembly 300, the at least one sensor module 110, the collector 400, and the at least one wireless control device. Further, the intermediary hub 100 is configured as a communication nexus for the wireless dust collection system 10 and may be further configured as a communication bridge between the wireless dust collection system 10 and an external network. In another embodiment of the invention, the intermediary hub 100 may be further configured to transfer and receive data from an external wireless control device through an external network. Data received or transferred by the intermediary hub 100 may include, but is not limited to, sensor module telemetry, wireless control device commands, air filter commands, and blast gate mechanism assembly 200 commands.

The intermediary hub 100 may be configured to receive a sensor module telemetry signals from the at least one sensor module 110. The at least one sensor module 110 may further be configured to measure, store, and transmit telemetry data on at least one parameter, including but not limited to, air quality, barometric air pressure, air flow, electrical current, electrical voltage, collection bin dust level, airborne particulate analysis, system component status, and battery or power level.

The intermediary hub 100 may be configured to receive a trigger telemetry signal from the at least on trigger assembly 300, the trigger telemetry comprising data on changes in electrical current through the trigger assembly 300. The trigger telemetry signal communicates to the intermediary hub 100 regarding the status of an implement or tool connected to the trigger assembly 300, and subsequently whether to transmit a command to a collector 400 or at least one blast gate mechanism assembly 200 to begin or end a process of dust collection by the system.

The intermediary hub 100 may be further configured to receive airflow telemetry from at least one sensor module 110, the airflow telemetry providing data on measured static pressures and total pressures throughout the dust collection system. The airflow telemetry may be utilized in modulation of the dust collection system either by the intermediary hub 100 itself or by a user in order to maintain efficient suction and airflow within the system.

The intermediary hub 100 may be further configured to receive collector bin 401 telemetry from at least one sensor module 110, the collector bin 401 telemetry indicating a level of collected dust within a collection bin 400. The collector bin 401 may be utilized by the intermediary hub 100 to determine whether to halt dust collection processes when the collector bin 401 is full or to transmit an indication signal to a user that the collector bin 401 must be emptied.

The intermediary hub 100 may be further configured to receive air quality telemetry from at least one sensor module 110, the air quality telemetry indicating a current level of particulate or dust present within any air moving through the dust collection system. The air quality telemetry may be utilized by the intermediary hub 100 itself by indicating when an air filter should be activated or whether to half dust collection processes when air quality may be hazardous to either a user or the system itself. The air quality telemetry may also be utilized by a user to determine whether an air filter should be changed, to monitor an overall efficiency of the dust collection system, or to modulate the dust collection system by indicating pre-determined situations where the intermediary hub 100 should halt dust collection processes, deactivate the air filter, or transmit an indication signal to a user that the air filter must be replaced.

The intermediary hub 100 may also be configured to receive telemetry signals from at least one tool or implement sensors coupled to a given tool or implement. These sensors may provide data including but not limited to user proximity, temperature, or orientation and may operate using radio frequency identification (RFID).

The intermediary hub 100 may be configured to transmit commands to the collector 400, indicating when the collector 400 should turn on or turn off to respectively begin or end the collection of dust by the system. The intermediary hub 100 may also be configured to transmit commands to the at least one blast gate mechanism assembly 200, indicating when the at least one blast gate mechanism should operate to open or close the blast gate during the process of dust collection by the system.

In other embodiments of the invention, the intermediary hub 100 may comprise an integrated wireless network adapter, the adapter configured to connect and communicate with the at least one blast gate mechanism assembly 200, the at least one trigger assembly 300, the at least one sensor module 110, and the collector 400. In another embodiment, the intermediary hub 100 may be configured to communicate with an external wireless network adapter, the adapter configured to connect and communicate with the at least one blast gate mechanism assembly 200, the at least one trigger assembly 300, the at least one sensor module 110, and the collector 400.

A person of ordinary skill in the art will understand and appreciate that a connection between the integrated or external wireless network adapter and the at least one blast gate mechanism assembly 200, the at least one trigger assembly 300, the at least one sensor module 110, and the collector 400 may comprise a known data transmission medium, including but not limited to, radio frequency (RF), Bluetooth, or infrared communications.

In another embodiment of the invention, the intermediary hub 100 may be further configured to have separate interfaces for both operational communication with at least component of the dust collection system and system maintenance communication with at least one component of the dust collection system. Operational communication may comprise sending commands to a given component of the dust collection system to facilitate dust collection processes. Maintenance communication may comprise transmittal of software or firmware updates to a given component, or exchange of component status data with the intermediary hub 100 to support overall functionality of the dust collection system.

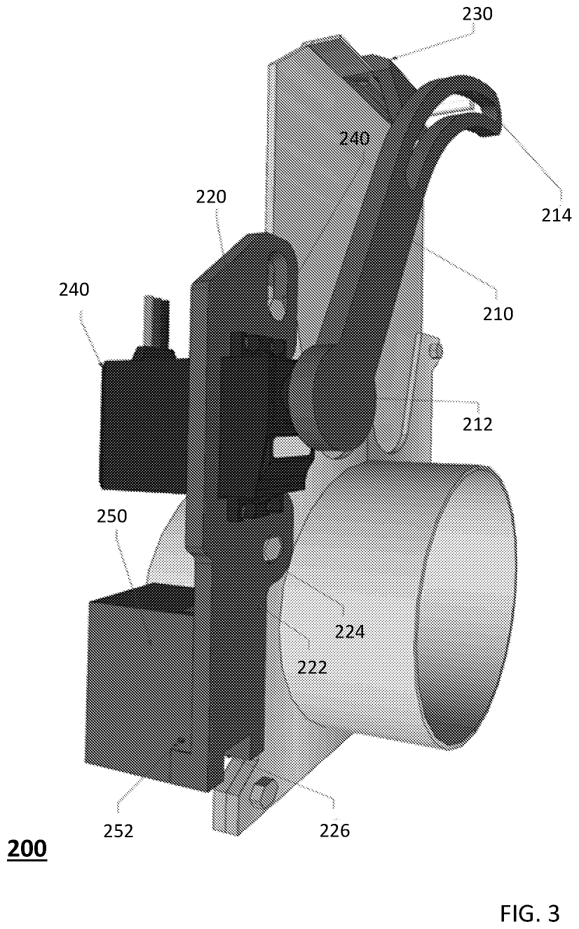

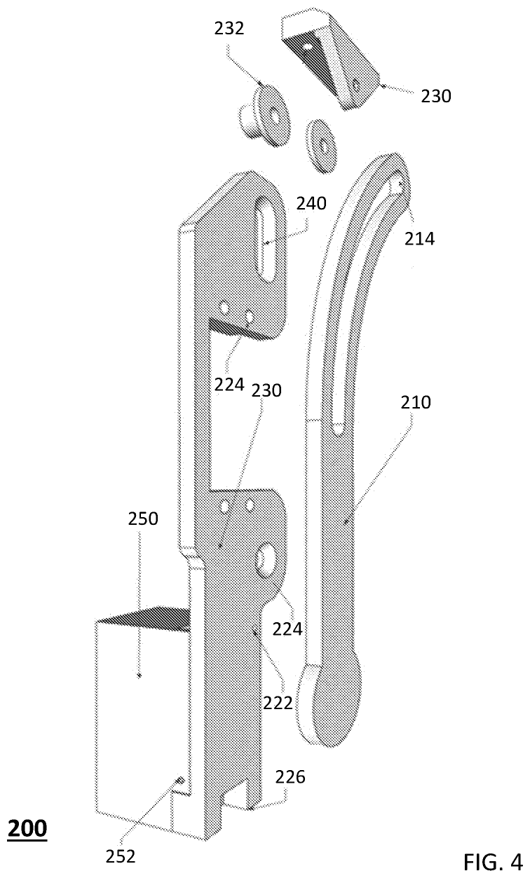

The dust collection system also comprises a blast gate mechanism assembly 200, as shown in FIGS. 3 and 4, the assembly comprising a force lever 210, an anchor plate 220, a sled member 230, a servomotor or rotary actuator 240, and a housing member 250. The blast gate mechanism assembly 200 is configured to couple a blast gate and open or close the blast gate through moving a plate of the blast gate a distance along a planar path.

The anchor plate 220 of the blast gate mechanism assembly 200 further comprises an attachment point configured to couple the housing member 250. The anchor plate 220 further comprises an opening 222 disposed through a surface and configured to securely couple a servomotor or rotary actuator. Further disposed through a surface, the anchor plate also comprises a plurality of attachment holes 224, configured to accept at least one attachment mechanism, such as a screw or nail. At an end, the anchor plate further comprises an opening 226 disposed through a surface thereof and configured to accept and couple a power supply coupling.

The force lever 210 of the blast gate mechanism assembly 200 may comprise an elongate member forming an arch shape and having a first end and a second end; the first end comprising an attachment point 212 and the second end having a sled drive channel 214 disposed through a main body of the elongate member. The attachment point 212 is further configured to couple a drive shaft of the servomotor or rotary actuator 240 and transfer rotational energy and force there through.

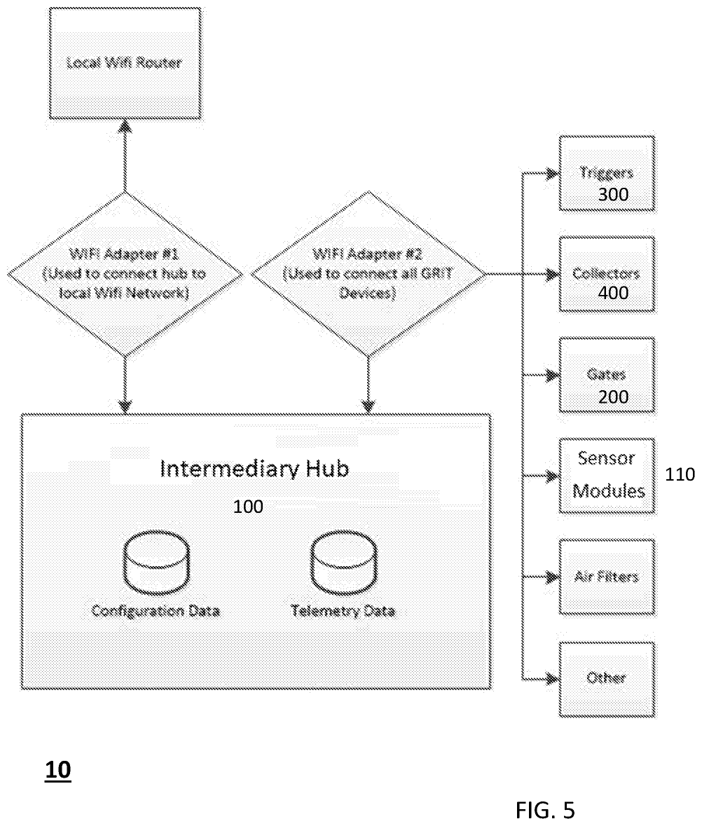

The sled drive channel 214 of the force lever is further configured to movably couple a sled member 230. The sled member 230 comprises a first end and a second end; the first end further comprising a sled bolt 232 coupled to the force lever and the second end having an attachment point configured to couple a plate of a blast gate. The sled bolt is also configured to facilitate transfer of force from the force lever to the sled member. In some embodiments of the invention, as shown in FIG. 5, the sled bolt may further comprise an expanded end 233 configured to couple and movably retain the force lever 210, allowing movement of the force lever 210 along a planar path while ensuring the sled bolt 230 remains with a plane of the planar path.

The housing member 250 of the blast gate mechanism assembly 200 comprises an enclosure having a top, a bottom, and a plurality of sidewalls. The housing member is further configured to retain at least one electrical component. Disposed through at least one sidewall, the housing member further comprises at least one attachment point 252 configured to couple the anchor plate and retain the housing member thereto. In some embodiments of the invention, the housing member may further comprise an opening disposed through one of the plurality of sidewalls and configured to accept and couple a power supply coupling (not shown).

During the course of operation, a signal may be transmitted to and received by the blast gate mechanism assembly 200. The signal may cause the servomotor or rotary actuator 240 to apply force to a drive shaft thereof, thereby causing rotation of the force lever 210. Rotational energy supplied by the servomotor 240 is then transferred through the force lever 210 and to the sled bolt 232 and sled member 230. Through the coupling of the sled bolt 232 to the sled drive channel 212 of the force lever 210, the rotational force is converted to a linear force as the sled bolt 232 moves along a path defined by the sled drive channel 210. The linear force is then transferred to the sled member 230 and then to the plate of the blast gate, thereby either pushing or pulling the plate in a direction along a planar path of the plate, effectively closing or opening the blast gate.

The at least one trigger assembly 300 of the dust collection system, as shown in FIG. 4, further comprises a first end 301, a second end 302, and a main enclosure 303. The first end 301 of the at least one trigger assembly 300 may comprise a female electrical coupler 310, while the second end 302 comprises a male electrical coupler 320. The first end and second end 301, 302 are configured such that the trigger assembly 300 may be coupled to an implement or tool such that it is in-line with an electrical supply to the implement or tool.

The main enclosure 303 of the trigger assembly 300 further comprises a microcontroller unit and a wireless communication device, both configured to interface with the intermediary hub 100 and transmit signals or telemetry thereto, further comprising data regarding a measure and status of electrical current being supplied through the trigger assembly 300 and to the connected implement or tool.

In another embodiment of the invention, the trigger assembly 300 may further be configured to halt and allow a flow of current to the connected tool or implement, effectively shutting it off or turning it on. The trigger assembly 300 may receive a command from the intermediary hub 100 in response to a user's input into a control device or in response to some other pre-determined parameter such as a surge in current, a drop in air quality or air flow, or a specified timer.

In another embodiment, a trigger assembly 300 may be coupled to the collector 400 of the wireless dust collection system, enabling a user to transmit a command to supply power to the collector 400, effectively turning on the overall system itself to begin dust collection processes.

In other embodiments, as shown in FIG. 4, an alternate embodiment of the trigger assembly 300 may be coupled to a collector 400 and configured to receive signal commands from the intermediary hub 100 to turn the collector 400 on or off. The trigger assembly 300 may further comprise an electrical sensor module configured to monitor current in at least one wire coupled to the trigger assembly 300. The electrical sensor may be further configured to communicate with both the microcontroller unit of the trigger assembly 300 and the intermediary hub 100 and receive signal commands to modulate a given current through the at least one wire. In doing so, the trigger assembly 300 facilitates turning the collector 400 off or on.

A person of ordinary skill in the art will understand and appreciate that the trigger assembly 300 may utilize hall effect sensing, current induction sensing, or any other sensing method known in the art to monitor current from a power supply to an implement or tool and to facilitate power supply control functions of the wireless dust collection system.

A person of ordinary skill in the art will further understand and appreciate that the dust collection system may utilize more than one collector 400 within the system through a use of at least one trigger assembly 300 connected to each collector 400. Doing so may enable multiple collectors to be activated at varying times specified by a user through the wireless control device.

The wireless control device of the dust collection system may comprise a computer or mobile application having a computer-implemented protocol and graphic user interface configured to allow a user to monitor each component of the dust collection system. The graphic user interface may further comprise executable protocols or actions configured to carry out actions within the dust collection system, enabling a user to modulate individual components of the system as well as an overall efficiency of the system. The executable protocols or actions may include, but are not limited to, partial opening or closing of at least one blast gate, timed opening of blast gates, scheduled activation of power supply to a collector 400, arrangement of active blast gates to modulate air flow within the system, or another function within the system.

In some embodiments, the wireless control device may further comprise one or more security protocols, including but not limited to password-based entry, username registration and entry, RFID proximity sensors, biometrics, or another credential-based system. The wireless control device may further be configured to remotely interface with and control the dust control system.

In one embodiment of the invention, a user may enact a system-wide shutdown or lock-out through the wireless control device, such that the dust collection system is shut off and cannot be activated until the user enables such function. The shutdown may be scheduled for certain times or enacted as the user wishes. The shutdown may further be lifted under circumstances specified by the user or through use of the security protocols. In some embodiments of the invention, the shutdown may comprise a localized tool lock-out protocol, wherein a user may specify one or more tools or implements that cannot be turned on by way of a trigger assembly 300. The localized lock-out protocol may further comprise an additional protocol by which at least one corresponding blast gate mechanism assembly 200 will also remain in a closed position, as well as a protocol preventing the collector 400 from being activated. A person of ordinary skill in the art will understand and appreciate that the localized tool lock-out protocol may be initiated or ended in a way similar to that of the system-wide shutdown.

The method of using the dust collection system as described involves the step of a user activating an implement or tool. A current is supplied to the trigger assembly 300, which records a change in current. The trigger assembly 300 then transmits a signal to the intermediary hub 100. The intermediary hub 100 receives the signal and accesses a predetermined or pre-supplied digital mapping of the dust collection system and determines which blast gate or blast gates must be open to allow any dust collected to flow to the collector 400 and collector bin 401. The intermediary hub 100 then sends a command signal to the blast gate mechanism assembly 200 of the system. A microcontroller unit and wireless communication device within the housing member of the blast gate mechanism assembly 200 receives the command signal. The microcontroller unit then sends a signal to the servomotor or rotary actuator. The servomotor then begins applying rotational force, which is then transferred to the force lever. The force lever begins to rotate about an axis, which then applies force to a sled bolt and sled member, thereby converting the rotational force to linear force. The sled member then moves a plate of the blast gate along a plane of said plate, thereby opening the blast gate.

The intermediary hub 100 then sends a signal to the trigger assembly 300 coupled to the collector 400, which enables flow of current from another power supply to the collector 400, thereby activating the collector 400 and beginning the process of collecting dust.

Deactivation of the dust collection system involves the aforementioned steps, replacing the steps of activating an implement or tool with deactivating the implement or tool. The steps are thereby performed wherein a trigger assembly 300 detects a change in current, but as an absence of current rather than an increase.

Those of ordinary skill in the art will understand and appreciate that the foregoing description of the invention has been made with reference to certain exemplary embodiments of the invention, which describe a wireless dust collection system and method of use. Those of skill in the art will understand that obvious variations in system configuration, protocols, parameters or properties may be made without departing from the scope of the invention which is intended to be limited only by the claims appended hereto.

What is claimed is:

1. A wireless dust collection system, comprising:
a. at least one blast gate mechanism assembly;
b. at least one wireless trigger assembly;
c. an intermediary hub;
d. at least one sensor module;
e. a collector;
f. a collector bin; and
g. at least one wireless control device.

2. The blast gate mechanism assembly of claim 1, further comprising a force lever, a sled bolt, a sled member, an anchor plate, a servomotor or rotary actuator, and a housing member.

3. The wireless trigger assembly of claim 1, further configured to modulate current through the assembly.

4. The intermediary hub of claim 1, further comprising a plurality of separate communication channels, wherein at least one communication channel comprises operational communications and at least one communication channel comprises maintenance communications.

5. The sensor module of claim 1, wherein the sensor module is configured to measure static pressures and total pressures throughout the dust collection system and transmit airflow telemetry to the intermediary hub.

6. The sensor module of claim 1, wherein the sensor module is configured to measure an amount of collected dust in the collector bin and transmit collector bin telemetry to the intermediary hub.

7. The sensor module of claim 1, wherein the sensor module is configured to measure airborne particulate within the dust collection system and transmit air quality telemetry to the intermediary hub.

8. The wireless dust collection system of claim 1, further comprising a security protocol configured to interface with the at least one wireless control device to allow access to and use of the at least one wireless control device.

9. The wireless dust collection system of claim 1, further comprising a security protocol configured to interface with the at least one wireless control device to allow access to and use of at least one tool or implement connected to the wireless dust collection system.

10. The wireless dust collection system of claim 1, wherein the at least one wireless control device is further configured to initiate a system-wide shutdown or lock-out, such that the dust collection system is shut off and cannot be activated until a user disables the system-wide shutdown or lock-out.

11. The wireless dust collection system of claim 10, wherein the system-wide shutdown or lock-out initiated by the at least one wireless control device is initiated by a user-input command.

12. The wireless dust collection system of claim 10, wherein the system-wide shutdown or lock-out initiated by the at least one wireless control device is initiated by a predetermined timing schedule.

13. The wireless dust collection system of claim 10, wherein the system-wide shutdown or lock-out initiated by the at least one wireless control device is initiated by a malfunction of at least one tool or implement connected to the system.

14. The wireless dust collection system of claim 1, wherein the at least one wireless control device is further configured to initiate a localized lock-out protocol, such that at least one tool or implement connected to the system is shut off and cannot be activated until a user disables the localized lock-out protocol.

15. The wireless dust collection system of claim 14, wherein the localized lock-out initiated by the at least one wireless control device is initiated by a user-input command.

16. The wireless dust collection system of claim 14, wherein the localized lock-out initiated by the at least one wireless control device is initiated by a predetermined timing schedule.

17. The wireless dust collection system of claim 14, wherein the localized lock-out initiated by the at least one wireless control device is initiated by a malfunction of at least one tool or implement connected to the system.

18. A method for using a dust collection system, comprising the following steps:
a. generating a digital reference map of the dust collection system, including locations of each component, and storing the digital reference map in an intermediary hub;
b. activating an implement or tool;
c. supplying current to a trigger assembly, the trigger assembly recording a change in current;
d. transmitting a signal to the intermediary hub, the intermediary hub receiving the signal and accessing the generated digital reference map;
e. determining which blast gate or blast gates must be open to allow collected dust to flow to a collector and a collector bin;
f. sending a command signal to at least one blast gate mechanism assembly;
g. sending a signal to a servomotor or rotary actuator of the at least one blast gate mechanism assembly;
h. utilizing a servomotor to apply a rotational force to a force lever of the blast gate mechanism assembly;
i. rotating the force lever about an axis, to apply force to a sled bolt and sled member of the blast gate mechanism assembly, thereby converting the rotational force to a linear force;
j. utilizing the sled member to move a plate of the blast gate along a plane and open the blast gate; and
k. sending a signal to a trigger assembly coupled to a collector unit to enable flow of current from a power supply to the collector unit, thereby activating the collector unit.

19. The method of claim 18, wherein the steps of activating an implement or tool are replaced with the step of deactivating an implement or tool.

20. The method of claim 19, wherein a trigger assembly detects an absence of current rather than an increase, in detecting a change in current.

21. A wireless dust collection system, comprising:
a. at least one wireless trigger assembly;
b. an intermediary hub;
c. a collector;
d. a collector bin; and
e. at least one wireless control device.

22. A blast gate mechanism assembly, comprising:
a. a force lever having a main body, a first end, and a second end, the first end comprising an attachment point and the second end having a sled drive channel disposed through the main body;
b. a sled member having a first end and a second end, the first end comprising a sled bolt configured to movably couple the sled member to the sled drive channel of the force lever, and the second end comprising an attachment point configured to couple a blast gate;
c. a housing member having a top, a bottom, and a plurality of sidewalls;
d. a servomotor or rotary actuator; and
e. an anchor plate having an attachment point configured to couple the housing member, an opening configured to couple the servomotor or rotary actuator, and a plurality of attachment holes.
